(19) United States
(12) Patent Application Publication
(10) Pub. No.: US 2022/0396711 A1
(43) Pub. Date: Dec. 15, 2022

(54) PRECOAT LIQUID AND METHOD FOR PRODUCING PRINTED MATTER USING THE SAME

(71) Applicant: Konica Minolta, Inc., Tokyo (JP)

(72) Inventors: Hiroyuki YASUKAWA, Tokyo (JP); Akihiro HONYA, Tokyo (JP); Teruo SASAKI, Tokyo (JP)

(21) Appl. No.: 17/828,776

(22) Filed: May 31, 2022

(30) Foreign Application Priority Data
Jun. 10, 2021 (JP) 2021-097186

(51) Int. Cl. C09D 11/54; C09D 11/033; C09D 11/037; C09D 11/101; B41M 5/00

(52) U.S. Cl. CPC C09D 11/54; C09D 11/033; C09D 11/037; C09D 11/101; B41M 5/0017

(57) ABSTRACT

An object of the present invention is to provide a precoat liquid which can prevent the penetration of an actinic radiation-curable ink into a recording medium and which is less likely to damage the texture of the recording medium. A precoat liquid, capable of achieving the object, for an actinic radiation-curable ink includes a hydrophilic polymer, a hydrophilic solvent, water, and resin fine particles. The amount of the hydrophilic polymer is 1 part by mass or more and 100 parts by mass or less with respect to 100 parts by mass of the hydrophilic solvent.

### CROSS REFERENCE TO RELATED APPLICATIONS

The entire disclosure of Japanese Patent Application No. 2021-097186 filed on Jun. 10, 2021 is incorporated herein by reference in its entirety.

### BACKGROUND

### Technological Field

The present invention relates to a precoat liquid and a method for producing a printed matter using the precoat liquid.

### Description of Related Art

Various printing methods are known for forming an image on various recording media. In particular, inkjet printing is widely used because the printing can be used for print on demand. For inkjet printing, an aqueous ink (namely water-based ink) containing water or the like as a solvent, an actinic radiation-curable ink that is cured by irradiation with actinic radiation, and the like are used.

When an aqueous ink is used, typically, the solvent in the aqueous ink is absorbed by a recording medium or volatilized. Only the solid content (for example, a colorant) in the aqueous ink is thus fixed on the surface of the recording medium. On the other hand, when an actinic radiation-curable ink is used, the cured product of the actinic radiation-curable ink is fixed on a recording medium. In other words, the actinic radiation-curable ink is preferably not absorbed by a recording medium. For example, when a part of the actinic radiation-curable ink is absorbed by the recording medium, the curability of the image may become insufficient, the image may not be fixed on the recording medium, and the like.

For using an actinic radiation-curable ink on an absorbent recording medium, performing a treatment that prevents the actinic radiation-curable ink from being absorbed by the recording medium is necessary. For example, application of a precoat liquid before the application of the actinic radiation-curable ink has been studied. Japanese Patent Application Laid-Open No. 2013-154645 describes application of a reaction solution containing water and a reactant to an absorbent recording medium.

WO 2014/021263 describes, for example, providing an ink receiving layer on the entire surface of a recording medium before the application of an aqueous ink for improving the drying property and the color developing property of the aqueous ink.

### SUMMARY

However, the method of Japanese Patent Application Laid-Open No. 2013-154645, in which a reaction solution containing water and a reactant is applied before the application of the actinic radiation-curable ink, cannot sufficiently prevent the penetration of the actinic radiation-curable ink, thereby more likely causing the bleeding and impairing the sharpness of the dots. One of the reasons therefor is that the reactant is dissolved, not in a form of particles. Alternatively, it is also possible to apply, for example, an actinic radiation-curable precoat liquid before the application of an actinic radiation-curable ink; however the cured product of the precoat liquid would thickly cover the surface of the recording medium, thus the texture of the recording medium is more likely to be impaired.

An object of the present invention is to provide a precoat liquid which can prevent the penetration of an actinic radiation-curable ink into a recording medium and which is less likely to damage the texture of the recording medium, and a method for producing a printed matter by using the precoat liquid.

To achieve at least one of the abovementioned objects, according to an aspect of the present invention, a precoat liquid reflecting one aspect of the present invention is as follows:

A precoat liquid for an actinic radiation-curable ink, the precoat liquid comprises a hydrophilic polymer; a hydrophilic solvent; water; and resin fine particles, in which the amount of the hydrophilic polymer is 1 part by mass or more and 100 parts by mass or less with respect to 100 parts by mass of the hydrophilic solvent.

To achieve at least one of the abovementioned objects, according to an aspect of the present invention, a method for producing a printed matter reflecting one aspect of the present invention comprises applying the precoat liquid on an recording medium having absorbency; and applying an actinic radiation-curable ink on a region, on which the precoat liquid is applied, in the recording medium and curing the actinic radiation-curable ink.

### DETAILED DESCRIPTION OF EMBODIMENTS

Hereinafter, one or more embodiments of the present invention will be described with reference to the drawings. However, the scope of the invention is not limited to the disclosed embodiments.

### 1. Precoat Liquid

It has been difficult to apply an actinic radiation-curable ink directly on an absorbent recording medium as described above. Actinic radiation-curable precoat liquids and water-based precoat liquids are thus studied. However, an actinic radiation-curable precoat liquid is more likely to damage the original texture of a recording medium. Meanwhile, when a conventional aqueous precoat liquid is used, an actinic radiation-curable ink is more likely to soak into a recording medium, requiring further improvement.

A precoat liquid of the present invention is a precoat liquid for an actinic radiation-curable ink and contains a hydrophilic polymer, a hydrophilic solvent, water, and resin fine particles. Herein, a precoat liquid for an actinic radiation-curable ink is a liquid to be applied on a recording medium before applying the actinic radiation-curable ink to the recording medium, and is particularly a liquid to be applied on an absorbent recording medium.

In the present invention, the amount of the hydrophilic polymer in the precoat liquid is 1 part by mass or more and 100 parts by mass or less with respect to 100 parts by mass of the hydrophilic solvent. An actinic radiation-curable ink is less likely to soak into a recording medium coated with the precoat liquid with this configuration, and the actinic radiation-curable ink thus can form a high-quality image. The reason therefor can be considered as follows.

When the precoat liquid of the present invention is applied on an absorbent recording medium, water and the hydrophilic solvent are absorbed by the recording medium. On the other hand, the hydrophilic polymer and the resin fine particles are not absorbed by the recording medium and remain on the surface of the recording medium. The actinic radiation-curable ink is less likely to soak into the recording medium when applied on the recording medium due to the presence of the resin fine particles. As the amount of the hydrophilic polymer is in the above range, an excessively thick layer is not formed on the surface of the recording medium, and the texture of the recording medium is less likely to be impaired.

Hereinafter, the precoat liquid of the present invention will be descried in detail. The precoat liquid of the present invention may contain components such as inorganic fine particles in addition to the hydrophilic polymer, the hydrophilic solvent, water, and the resin fine particles within a range that does not impair the objects and the effects of the present invention.

Hydrophilic Polymer

The hydrophilic polymer contained in the precoat liquid may be any polymer that can be uniformly dissolved or dispersed in a hydrophilic solvent and water. Herein, a hydrophilic polymer being “hydrophilic” means that the polymer contains 1 mass % or more of a component(s) that has passed through a membrane filter (filter diameter of 1 μm) when 0.05 g of the polymer is dissolved in 50 cm³ of ion-exchanged water at 90° C. under stirring (using a stirrer chip or the like) to equilibrium and treated with the membrane filter.

When the precoat liquid of the present invention is applied on an absorbent recording medium, the hydrophilic polymer adheres to the surface of the recording medium and is fixed. As a result, the actinic radiation-curable ink is less likely to be absorbed by the recording medium. More specifically, a hydrophilic polymer is hydrophilic, and an actinic radiation-curable ink is usually hydrophobic. The hydrophobic actinic radiation-curable ink is thus less likely to soak into the recording medium with the hydrophilic polymer attached thereon in advance, and more likely to stay on the surface of the recording medium. The precoat liquid may contain only one type of hydrophilic polymer, or two or more types of hydrophilic polymers.

The type of hydrophilic polymer is not limited, and examples thereof include sugars that contain a sugar or a polysaccharide in a part of the chemical structure thereof. Examples of the sugars include gellan gum, psyllium seed gum, locust bean gum, xanthan gum, guar gum, tara gum, tamarind seed gum, karaya gum, chitosan, arabic gum, ghatti gum, glucomannan, tragant gum, agar, carrageenan (for example, iota carrageenan), alginic acid, sodium alginate, calcium alginate, propylene glycol alginate, HM pectin, LM pectin, Azotobacter vinelandii gum, curdlan, pullulan, dextran, and cellulose derivatives (for example, sodium carboxymethyl cellulose, calcium carboxymethyl cellulose, methyl cellulose, hydroxypropyl cellulose, and hydroxyethyl cellulose).

Other examples of the hydrophilic polymer include polyvinyl alcohols and nitrogen-containing compounds containing nitrogen in the molecule thereof. Examples of the nitrogen-containing compounds include polyethyleneimine, epichlorohydrin-modified polyalkylamine, polyamine, polyamine polyamide epichlorohydrin, dimethylamine ammonia epichlorohydrin, polyvinylbenzyltrimethylammonium halide, polydiacrylic dimethylammonium halide, diallyldimethyl-ammoniumchloride acrylamide copolymer, polydimethylaminoethyl methacrylate hydrochloride, polyvinylpyridium halide, cationic polyacrylamide, nonionic polyacrylamide, cationic polystyrene copolymer, diallyldimethyl-ammoniumchloride polymer, diallyldimethylammonium chloride-sulfur dioxide copolymer, diallyldimethylammonium chloride amide copolymer, dicyandiamide formalin polycondensate, dicyandiamide diethylenetriamine polycondensate, polyallylamine, polydiallylamine, polyallylamine hydrochloride, polyacrylamide resin, polyamide epoxy resin, melamine resin acid colloid, urea resin, amino acid type amphoteric surfactant, polyamidine compound, and cationic modified polyurethane resin.

Among the examples of the hydrophilic polymer, a nitrogen-containing compound is particularly preferred because the compound improves the wettability and spreadability of the actinic radiation-curable ink. More preferred are, for example, polyacrylamides, diallyldimethyl-ammoniumchloride polymer, and diallyldimethyl-ammoniumchloride acrylamide copolymer.

The viscosity of the hydrophilic polymer at 25° C. measured by a B-type viscometer is preferably 10 mPa·s or more and 10,000 mPa·s or less, and more preferably 100 mPa·s or more and 5,000 mPa·s or less.

The amount of the hydrophilic polymer in the precoat liquid is preferably 1 part by mass or more and 100 parts by mass or less, more preferably 1 part by mass or more and 40 parts by mass or less, with respect to 100 parts by mass of a hydrophilic solvent described below.

Hydrophilic Solvent

The hydrophilic solvent contained in the precoat liquid is compatible with water, and the above described hydrophilic polymer can be uniformly dispersed or dissolved in the hydrophilic solvent. Herein, a hydrophilic solvent being “hydrophilic” means that the solvent has a Log P value of 2 or less. The precoat liquid may contain only one type of hydrophilic solvent, or two or more types of hydrophilic solvents.

Examples of the hydrophilic solvent include monohydric alcohols such as methanol, ethanol, propanol, isopropanol, butanol, isobutanol, secondary butanol, tertiary butanol, pentanol, hexanol, cyclohexanol, and benzyl alcohol; polyhydric alcohols such as ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thiodiglycol; polyhydric alcohol ethers such as ethylene glycol monomethyl ether, ethylene glycol monoethyl ether, ethylene glycol monobutyl ether, ethylene glycol monophenyl ether, diethylene glycol monomethyl ether, diethylene glycol monoethyl ether, diethylene glycol monobutyl ether, diethylene glycol dimethyl ether, propylene glycol monomethyl ether, propylene glycol monobutyl ether, ethylene glycol, monomethyl ether acetate, triethylene glycol monomethyl ether, triethylene glycol monoethyl ether, triethylene glycol monobutyl ether, triethylene glycol dimethyl ether, dipropylene glycol monopropyl ether, and tripropylene glycol dimethyl ether; amines such as ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamethyldiethylenetriamine, and tetramethylpropylenediamine; amides such as formamide, N,N-dimethylformamide, and N,N-dimethylacetamide; heterocycles such as 2-pyrrolidone, N-methyl-2-pyrrolidone, N-cyclohexyl-2-pyrrolidone, 2-oxazolidone, and 1,3-dimethyl-2-imidazolidinone; sulfoxides such as dimethyl sulfoxide; sulfones such as sulfolane; sulfonates such as sodium 1-butanesulfonate; acetonitrile; and acetone.

In particular, a hydrophilic solvent having two or more hydroxyl groups in the molecule thereof is preferred from the viewpoint of affinity with water, boiling point and the like, and a hydrophilic solvent having three or more hydroxyl groups in the molecule thereof is more preferred. Specifically, a dihydric alcohol such as polyethylene glycol or polypropylene glycol, or a trihydric or higher alcohol such as glycerin or hexanetriol are preferred. A trihydric or higher alcohol is more preferred.

The boiling point of the hydrophilic solvent is preferably 100° C. or higher, more preferably 100° C. or higher and 250° C. or lower, and even more preferably 150° C. or higher and 200° C. or lower, from the viewpoint of preventing curling of a printed matter. A hydrophilic solvent having a boiling point equal to or higher than the boiling point of water (i.e., 100° C.) partly remains in a recording medium after the evaporation of water. As the precoat liquid dries slowly, the printed matter is less likely to curl.

The amount of the hydrophilic solvent is preferably 10 mass % or more and 80 mass % or less, more preferably 20 mass % or more and 65 mass % or less, based on the total amount of the precoat liquid. A hydrophilic solvent whose amount is in the above range can improve the drying property and the coatability of a precoat liquid.

Water

The precoat liquid of the present invention contains water in addition to the above described hydrophilic polymer and hydrophilic solvent. The amount of water is preferably 10 parts by mass or more and 120 parts by mass or less, more preferably 20 parts by mass or more and 100 parts by mass or less, with respect to 100 parts by mass of the hydrophilic solvent. Water whose amount is in the above range can improve the drying property and the coatability of a precoat liquid.

Resin Fine Particles

The precoat liquid further contains resin fine particles as described above. The resin fine particles prevent the soaking of an actinic radiation-curable ink. The presence of resin fine particles in the precoat liquid gives another advantage such that the wettability and spreadability of the actinic radiation-curable ink is more likely to increase. The hydrophilic polymer and the polymerizable compound (for example, acrylic monomer) in an actinic radiation-curable ink usually have significantly different SP values. Therefore, when an actinic radiation-curable ink is applied on a recording medium coated with the precoat liquid, the actinic radiation-curable ink may be repelled by the hydrophilic polymer and the wettability and spreadability may decrease. On the other hand, the resin fine particles are relatively easy to be blended with the polymerizable compound in the actinic radiation-curable ink. Therefore, when the prepolymer liquid contains resin fine particles, the actinic radiation-curable ink is less likely to be repelled, and can appropriately wet the recording medium and spread on the recording medium.

The resin fine particles may be any fine particles that are insoluble in water and a hydrophilic solvent, and contain a resin. The size of the resin fine particles is not particularly limited, but the volume 50% average particle diameter (hereinafter, also referred to as “D₅₀”) measured by a laser light scattering method is preferably 0.2 to 150 μm, more preferably 0.2 to 100 μm. Resin fine particles with volume 50% average particle diameter of 0.2 μm or more are more likely to increase the affinity between the recording medium coated with the precoat liquid and the actinic radiation-curable ink. Resin fine particles with volume 50% average particle diameter of 150 μm or less are less likely to affect the image formed from the actinic radiation-curable ink. The 50% volume average particle diameter is a volume average value of the particle diameters of the resin fine particles measured by a laser light scattering method.

The type and the like of resin fine particles are not limited as long as the resin fine particles can be uniformly dispersed in the above described hydrophilic solvent and water. The precoat liquid may contain two or more types of resin fine particles. Examples of resins constituting the resin fine particles include olefin resins such as polyethylene and polypropylene; polystyrene resins; acrylic resins such as polyacrylates; polyamide resins; silicon resins; phenol resins; rubbers such as styrene-butadiene rubbers; and latex polymers and emulsion polymers.

In particular, for example, acrylic resins and styrene-butadiene rubbers are preferred.

The amount of the resin fine particles is preferably 1 part by mass or more and 100 parts by mass or less, more preferably 1 part by mass or more and 40 parts by mass or less, with respect to 100 parts by mass of the hydrophilic solvent. Resin fine particles whose amount is 1 part by mass or more improves the wettability and spreadability of the actinic radiation-curable ink applied on a recording medium. Resin fine particles whose amount is 100 parts by mass or less are less likely to affect the image formed from the actinic radiation-curable ink.

Inorganic Fine Particles

The precoat liquid may further contain inorganic fine particles. The inorganic fine particles may be any fine particles that are insoluble in water and a hydrophilic solvent, and are composed of an inorganic material. The size of the inorganic fine particles is not particularly limited, but the volume 50% average particle diameter (hereinafter, also referred to as “D₅₀”) measured by a laser light scattering method is preferably 0.2 to 10 μm, more preferably 0.3 to 5 μm. Inorganic fine particles with volume 50% average particle diameter of 0.2 μm or more are less likely to allow an actinic radiation-curable ink to soak into the recording medium coated with the precoat liquid. Inorganic fine particles with volume 50% average particle diameter of 10 μm or less are less likely to affect the image formed from the actinic radiation-curable ink. The 50% volume average particle diameter is a volume average value of the particle diameters of the inorganic fine particles measured by a laser light scattering method.

The inorganic fine particles are not limited as long as the inorganic fine particles can be uniformly dispersed in the above described hydrophilic solvent or the like. Examples of materials constituting the inorganic fine particles include vapor phase silica, colloidal silica, titanium dioxide, barium sulfate, calcium silicate, zeolite, kaolin, halloysite, mica, talc, calcium carbonate, magnesium carbonate, calcium sulfate, pseudoboehmite, zinc oxide, zinc hydroxide, alumina, aluminum silicate, calcium silicate, magnesium silicate, zirconium oxide, zirconium hydroxide, cerium oxide, lanthanum oxide, and yttrium oxide.

In particular, vapor phase silica, calcium carbonate, talc, or kaolin is preferred from the viewpoint of handling and the like.

The amount of the inorganic fine particles is preferably 0 part by mass or more and 50 parts by mass or less, more preferably 3 parts by mass or more and 40 parts by mass or less, with respect to 100 parts by mass of the hydrophilic solvent. Inorganic fine particles whose amount is 10 parts by mass or more are more likely to prevent the soaking of an actinic radiation-curable ink applied on a recording medium. Inorganic fine particles whose amount is 100 parts by mass or less are less likely to affect the image formed from the actinic radiation-curable ink.

Preparation Method and Physical Properties of Precoat Liquid

A precoat liquid can be prepared by mixing the above described hydrophilic polymer, hydrophilic solvent, water, and resin fine particles, and as necessary, inorganic fine particles. All the components may be mixed at once, or only some components (for example, other than the hydrophilic solvent) may be mixed in advance and the remaining components (for example, hydrophilic solvent) may be added afterward.

The viscosity of the precoat liquid is appropriately selected depending on the method for applying the precoat liquid on a recording medium. For example, for applying the precoat liquid by the inkjet method, the viscosity of the precoat liquid measured by B-type viscometer at 25° C. under the condition of No. 1 rotor, No. 2 rotor or No. 3 rotor is preferably 100 Pa s or more and 20,000 Pa s or less, more preferably 100 Pa s or more and 1,000 Pa s or less. A precoat liquid whose viscosity is in the above range can sufficiently reduce the thickness of the hydrophilic polymer remaining on the recording medium, and less likely to impair the texture of the recording medium.

### 2. Method for Producing Printed Matter

The above described precoat liquid can be used in the following method for producing a printed matter. However, the precoat liquid may be used in any method other than the following method.

The method for producing a printed matter that uses the precoat liquid includes the following steps: applying the precoat liquid on an absorbent recording medium; and applying an actinic radiation-curable ink on a region, on which the precoat liquid is applied, in the recording medium and curing the actinic radiation-curable ink.

The recording medium used for the printed matter may be any recording medium having a surface that absorbs a liquid such as ink, and is appropriately selected depending on the intended use of the printed matter. The recording medium may be composed of one layer or may be a laminate of a plurality of layers. In addition, the recording medium may have a shape of a flat sheet or a long shape such as a roll. Further, the recording medium may have a three-dimensional shape.

The absorbency of the recording medium can be measured, for example, as follows. Dropping 0.5 μL water droplet on a recording surface of the recording medium, and observing the reduction rate of the contact angle (comparison between the contact angle at 0.5 milliseconds and the contact angle at 5 seconds after landing) can determine whether the recording medium is absorbent (has absorbency) or not. Specifically, a recording medium having high absorbency has a large reduction rate of the contact angle, and a recording medium having low absorption has a small reduction rate of the contact angle. Herein, an absorbent recording medium is a recording medium having a reduction rate of the contact angle of 5.0% or more. Any device may be used for measuring the contact angle, and for example, a portable contact angle meter PCA-1 manufactured by Kyowa Interface Science Co., Ltd can be used.

Examples of the recording media include plain paper from thin paper to thick paper, medium-quality paper, high-quality paper, recycled paper, coated printing paper such as art paper and coated paper, commercially available Japanese paper, postcard paper, and cloth.

The method for applying the precoat liquid may be any method that can apply the precoat liquid on a recording medium prior to the application of an actinic radiation-curable ink. Examples of such a method include inkjet methods, gravure coating methods, and spray coating methods. The precoat liquid may be applied only on a part of the recording medium, or may be applied on the entire surface of the recording medium.

The amount of the precoat liquid to be applied is not limited, but is usually preferably 0.1 g/m² to 20 g/m², more preferably 0.2 g/m² to 5 g/m². Setting the application amount of the precoat liquid within the range enables easy forming of an image from the actinic radiation-curable ink on the recording medium coated with the precoat liquid.

After applying the precoat liquid, the recording medium may be dried as necessary. The drying method may be air drying, hot air drying, infrared heating or the like. The drying time is not limited, which is usually from about 0.5 seconds to about 5 seconds.

Subsequently, an actinic radiation-curable ink is applied on the region—on which the precoat liquid is applied—of the recording medium. Herein, an actinic radiation-curable ink is an ink that can be cured by irradiation with light rays such as electron beams, ultraviolet rays, visible rays, a rays, y rays, or X-rays. The type of actinic radiation-curable ink is not limited, and may be, for example, an ultraviolet curable type (hereinafter, also referred to as “UV curable”) ink that is cured by ultraviolet rays.

The actinic radiation-curable ink may have any composition, and may be a known actinic radiation-curable ink that contains a polymerizable compound such as an acrylic monomer that can be polymerized by irradiation with actinic radiation, a polymerization initiator, a colorant, various additives, and the like. The actinic radiation-curable ink may contain, for example, a gelling agent such as wax.

Any one of various known methods may be used for applying the actinic radiation-curable ink. An inkjet method specifically is capable of obtaining the above described effect of the precoat liquid. The viscosity of an actinic radiation-curable ink to be applied by the inkjet method is relatively low as compared with the viscosity of an actinic radiation-curable ink to be applied by other methods. Therefore, when the actinic radiation-curable ink is dropped directly on a recording medium, the components in the actinic radiation-curable ink easily soak into the recording medium. Using the above described precoat liquid can prevent such soaking.

The viscosity of the actinic radiation-curable ink is not limited, and is appropriately selected depending on the method for applying the actinic radiation-curable ink. For example, when an actinic radiation-curable ink contains a gelling agent, and the inkjet method is used for the application of the actinic radiation-curable ink, the viscosity of the actinic radiation-curable ink at 80° C. is preferably 3 mPa·s or more and 20 mPa·s or less from the viewpoint of further enhancing the ejection performance from the inkjet head. When the viscosity at 80° C. is 3 mPa s or more and 20 mPa·s or less, the actinic radiation-curable ink is less likely to gel at the time of ejection, enabling more stable ejection of the actinic radiation-polymerizable compound.

In addition, when the actinic radiation-curable ink contains a gelling agent, the viscosity of the actinic radiation-curable ink at 25° C. is preferably 1,000 mPa·s or more from the viewpoint of allowing the ink to sufficiently gel during the landing and cooling to room temperature. When the viscosity at 25° C. is 1,000 mPa·s or more, ink droplets applied to an intermediate transfer member are less likely to spread and to coalesce with each other. The viscosities of an actinic radiation-curable ink at 40° C. and 80° C. can be obtained by measuring the temperature change of the dynamic viscoelasticity of the actinic radiation-curable ink with a rheometer.

For example, the viscosities of an actinic radiation-curable ink at 25° C. and 80° C. can be obtained as follows: the actinic radiation-curable ink is heated to 100° C., then while viscosity is measured with a stress-controlled rheometer (Physica MCR301 (cone plate diameter: 75 mm, cone angle: 1.0°) manufactured by Anton Paar), the viscosities at 25° C. and 80° C. are respectively read on the temperature change curve of the viscosity obtained by cooling the ink to 25° C. under the conditions of a shear rate of 11.7 (1/s) and a temperature lowering rate of 0.1° C./s.

After applying the actinic radiation-curable ink, the obtained coating film is irradiated with actinic radiation to cure the actinic radiation-curable ink. The type of actinic radiation, irradiation intensity, irradiation time, and the like are appropriately selected according to the type of actinic radiation-curable ink. As a result, a printed matter having a high quality image can be obtained.

Although embodiments of the present invention have been described and illustrated in detail, the disclosed embodiments are made for purpose of illustration and example only and not limitation. The scope of the present invention should be interpreted by terms of the appended claims.

### EXAMPLES

Hereinafter, specific examples of the present invention will be described together with comparative examples, but the present invention is not limited thereto. In the examples, “parts” and “%” mean “parts by mass” and “mass %” unless otherwise specified.

### 1. Preparation of Material

Hydrophilic Polymer
Calcium alginate (CAW-80, manufactured by KIMICA Corporation)
Iota carrageenan (manufactured by Gokyo Food Co., Ltd.)
Amphoteric polyacrylamide (Harmide KS-38, manufactured by Harima Chemicals Group, Inc.)
Diallyldimethyl-ammoniumchloride polymer 1 (PAS-H-1L, manufactured by Nittobo Medical Co., Ltd.)
Diallyldimethyl-ammoniumchloride acrylamide copolymer (PAS-J-81, manufactured by Nittobo Medical Co., Ltd.)
Nonionic polyacrylamide (Haricoat 1057, manufactured by Harima Chemicals Group, Inc.)
Diallyldimethyl-ammoniumchloride polymer 2 (PAS-H-5L, manufactured by Nittobo Medical Co., Ltd.)
Polyvinyl alcohol (PVA117, manufactured by Kuraray Co., Ltd.)
Polyallylamine hydrochloride polymer (PAA-HCL-3L, manufactured by Nittobo Medical Co., Ltd.)

Hydrophilic Solvent
Polyethylene glycol
Polypropylene glycol
Glycerin
Isopropyl alcohol
1,2-Hexanediol

Resin Fine Particle
Acrylic particles (TOCRYL (registered trademark) W168, manufactured by TOYOCHEM Co., Ltd., D₅₀: 100 μm)
Styrene/butadiene rubber 1 (JSR0561, manufactured by JSR Corporation, D₅₀: 220 nm)
Styrene/butadiene rubber 2 (JSR0589, manufactured by JSR Corporation, D₅₀; 700 nm)

Inorganic Fine Particles
Kaolin 1 (manufactured by Hayashi Pure Chemical Ind., Ltd., D₅₀: 150 μm)
Kaolin 2 (manufactured by Hayashi Pure Chemical Ind., Ltd., D₅₀: 100 μm)
Calcium carbonate (FMT-100, manufactured by FIMATEC Ltd., D₅₀: 0.72 μm)
Talc (manufactured by FIMATEC Ltd., D₅₀: 10.2×1.02 μm)
Vapor phase silica (HDK-T30, manufactured by Wacker Chemie AG, D₅₀: 0.2 μm)

Additional Component
Magnesium chloride

### 2. Preparation of Precoat Liquid

### Examples 1 to 19 to Comparative Example 1

As shown in Tables 1 and 2 below, a hydrophilic polymer, a hydrophilic solvent, and water, and as necessary, resin fine particles and inorganic fine particles were mixed to prepare a precoat liquid.

### Comparative Example 2

The following components were mixed to prepare a precoat liquid.
Tricyclodecanedimethanol diacrylate: 14.70 parts by mass
Dipropylene glycol diacrylate: 32.90 parts by mass
di-Propoxylated neopentyl glycol diacrylate: 11.20 parts by mass
2,4,6-Trimethylbenzoyl diphenylphosphine oxide: 9.80 parts by mass
Isopropyl alcohol: 15.00 parts by mass
1-Butyl alcohol: 15.00 parts by mass
UV-12 (FLORSTABUV-12, manufactured by Kromachem Ltd.): 0.70 parts by mass
TEGORAD 2100 (manufactured by Evonik Industries): 1.00 part by mass

### Comparative Example 3

The following components were mixed to prepare a precoat liquid.
Heavy calcium carbonate (manufactured by Sankyo Seifun Co., Ltd., Escalon #200, D₅₀: 4.9 μm): 100 parts by mass
Completely saponified polyvinyl alcohol (PVA 117, manufactured by Kuraray Co., Ltd.): 3.0 parts by mass
Completely saponified polyvinyl alcohol (PVA 103, manufactured by Kuraray Co., Ltd.): 1.0 part by mass
Polyamine epihalohydrin resin (DK6800, manufactured by SEIKO PMC Corporation): 15.0 parts by mass
Water: 32.0 parts by mass

### Comparative Example 4

The following components were mixed to prepare a precoat liquid.
Polyallylamine hydrochloride polymer (PAA-HCL-3L, manufactured by Nittobo Medical Co., Ltd.): 20 parts by mass
1,2-Hexanediol: 5 parts by mass
Triethanolamine: 1 part by mass
BYK-347 (manufactured by BYK Japan KK): 0.2 parts by mass
Proxel XL2 (manufactured by Lonza): 0.2 parts by mass
Irgacure 819DW (manufactured by BASF): 2 parts by mass
Water: 71.6 parts by mass

### 3. Evaluation

The precoat liquids were evaluated by the following methods.

(1) Paper Texture Evaluation

Each of the above precoat liquids was applied at the application amount of 0.3 g/m² on a recording medium (OK Top Coat paper 128 g/m², manufactured by Oji Paper Co., Ltd.) by using an inkjet device (KM-1 manufactured by Konica Minolta, Inc.). The application pattern was a solid image of a square of 30 mm×30 mm. The precoat liquid of comparative example 1 was cured by irradiating with light having a wavelength of 385 nm at an exposure amount of 30 mJ. The other precoat liquids were heated and dried in a drying oven at 80° C. for 5 minutes and then evaluated. The evaluation was visually performed according to the following criteria.

Excellent: The texture of the recording medium is not impaired.

Good: The texture of the recording medium is slightly impaired.

Poor: The texture of the recording medium is impaired.

(2) Ink Permeability Evaluation

Each of the above precoat liquids was applied at the application amount of 0.3 g/m² on a recording medium (OK Top Coat paper 128 g/m², manufactured by Oji Paper Co., Ltd.) by using an inkjet device (KM-1 manufactured by Konica Minolta, Inc.), and dried. The application pattern was a solid image of a square of 30 mm×30 mm. Further, the precoat liquid of comparative example 1 was applied and cured in the same manner as in the paper texture evaluation.

A UV curable ink (KM-1 cyan ink manufactured by Konica Minolta, Inc.) was prepared. Subsequently, 0.1 of the UV curable ink was dropped onto the region, where the precoat liquid was applied, in the recording medium by using a contact angle meter PCA-11. The state of the ink on the region at this time was visually observed using the image observation of the contact angle meter, and evaluated according to the following criteria.

Excellent: The UV curable ink remains on the recording medium even after 5 seconds have passed since the UV curable ink was dropped.

Good: The UV curable ink remains on the recording medium even after 1 second has passed since the UV curable ink was dropped, but the ink soaks within 5 seconds.

Poor: The UV curable ink soaks before 1 second has passed since the UV curable ink was dropped.

(3) Evaluation on Wettability and Spreadability of Ink

Each of the above precoat liquids is applied at the application amount of 0.3 g/m² on a recording medium (OK Top Coat 128, manufactured by Oji Paper Co., Ltd.) by using an inkjet device (KM-1 manufactured by Konica Minolta, Inc.). The application pattern was a solid image. After applying the precoat liquid, the recording medium was dried in a drying oven at 80° C. for 5 minutes and then subjected to image printing. Further, the precoat liquid of comparative example 1 was applied and cured in the same manner as in the paper texture evaluation. The inkjet device (KM-1 manufactured by Konica Minolta Inc.) was filled with the same UV curable ink as the above evaluation. Each recording medium was conveyed to the inkjet device at 600 m/s, and the UV curable ink was applied on the region, on which the precoat liquid was applied, to form a halftone image of 10% density. Irradiation with light having a wavelength of 385 nm from a UV-LED lamp at an exposure amount of 500 mJ/cm² was performed to produce 10 printed matter. Subsequently, the dot diameter of the halftone portion was observed. The evaluation was performed according to the criteria below. When a halftone image of 10% density is formed on the recording medium with the UV curable ink (without applying a precoat liquid), the dot diameter of the cured ink in the halftone portion formed on the recording medium is 40 to 50 μm.

Excellent: The dot diameter of the cured ink of the obtained printed matter is 65 μm or more.

Good: The dot diameter of the cured ink of the obtained printed matter is 50 μm or more and less than 65 μm.

Poor: The dot diameter of the cured ink of the obtained printed matter is less than 50 μm.

(4) Fixability Evaluation

Each precoat liquid was applied on the recording medium, and then a solid image of 30 mm×30 mm was formed with the UV curable ink in the same manner as in the above evaluation on wettability and spreadability of ink. The obtained printed matter was cut with a push-cut blade. Cellophane tape (plant-based) manufactured by NICHIBAN Co., Ltd. was attached along the cut surface, and the cellophane tape was peeled off while maintaining the angle between the printed matter and the tensile direction at 90°. The cellophane tape after peeling was visually observed and evaluated as follows.

Excellent: No peeling printed matter adheres to the cellophane tape.

Good: A part of printed matter (cured UV curable ink) adheres to the cellophane tape.

Poor: The printed matter adheres to the entire surface of the cellophane tape.

(5) Evaluation of Dot Sharpness

Each precoat liquid was applied on the recording medium, and then a halftone image of 10% density was formed with the UV curable ink in the same manner as in the above evaluation on wettability and spreadability of ink. The shape of the dots in the halftone portion in the obtained printed matter was observed.

Excellent: The outline of the dots is clear.

Good: The outline of the dots is blurred, but practical use is possible.

Poor: The outline of the dots is not clear and practical use is not possible.

(6) Curling Property

Each precoat liquid was applied on a recording medium (OKTC128 manufactured by Oji Paper Co., Ltd.) with a wire bar #3, which was placed in a drying oven and dried at 80° C. for 5 minutes. The precoat liquid of comparative example 1 was subjected to photocuring in the same manner as described above. Subsequently, the printed matter was placed on a flat plate, and the distance from the flat place to each of four corners was observed. The evaluation was visually performed according to the following criteria.

Excellent: The maximum distance from the flat place to the four corners is less than 10 mm.

Good: The maximum distance from the flat place to the four corners is 10 mm or more and less than 25 mm.

Poor: The maximum distance from the flat place to the four corners is 25 mm or more.

TABLE 1

| | | Comp. Ex. 1 | Ex. 1 | Ex. 2 | Ex. 3 | Ex. 4 |
|---|---|---|---|---|---|---|
| Hydrophilic | Type | Calcium | Iota | Calcium | (KS-38)** | (KS-38)** |
| polymer | | alginate | carrageenan | alginate | | |
| | | (CAW-80) | | (CAW-80) | | |
| | Amount* | 100 | 100 | 100 | 40 | 40 |
| Hydrophilic | Type | Polyethylene | Polyethylene | Polyethylene | Polyethylene | Polyethylene |
| solvent | | glycol | glycol | glycol | glycol | glycol |
| | Amount* | 100 | 100 | 100 | 100 | 100 |
| Water | Amount* | 100 | 40 | 40 | 40 | 40 |
| Resin fine | Type | — | Acrylic | Acrylic | Acrylic | Acrylic |
| particles | | | particles | particles | particles | particles |
| | D₅₀ | — | 100 μm | 100 μm | 100 μm | 100 μm |
| | Amount* | — | 100 | 100 | 100 | 100 |
| Inorganic | Type | — | — | Kaolin 1 | Kaolin 1 | Kaolin 2 |
| fine | D₅₀ | — | — | 150 μm | 150 μm | 100 μm |
| particles | Amount* | — | — | 20 | 20 | 20 |

| | | | | | |
|---|---|---|---|---|---|
| Recording medium | Excellent | Excellent | Good | Good | Good |
| texture | | | | | |
| UV curable ink | Poor | Good | Excellent | Excellent | Excellent |
| permeability | | | | | |
| UV curable ink | Good | Excellent | Excellent | Excellent | Excellent |
| wettability and | | | | | |
| spreadability | | | | | |
| UV curable ink | Good | Good | Good | Good | Good |
| fixability | | | | | |
| Dot Sharpness | Good | Good | Good | Good | Good |
| Curling property | Excellent | Excellent | Excellent | Excellent | Excellent |

| | | Ex. 5 | Ex. 6 | Ex. 7 | Ex. 8 | Ex. 9 |
|---|---|---|---|---|---|---|
| Hydrophilic | Type | (PAS-H-1L)*** | (PAS-J-81)**** | Nonionic | Diallyldimethyl- | Diallyldimethyl- |
| polymer | | | | polyacrylamide | ammoniumchloride | ammoniumchloride |
| | | | | (Haricoat 1057) | polymer 2 | polymer 2 |
| | | | | | (PAS-H-5L) | (PAS-H-5L) |
| | Amount* | 40 | 40 | 40 | 40 | 30 |
| Hydrophilic | Type | Polypropylene | Glycerin | Glycerin | Glycerin | Glycerin |
| solvent | | glycol | | | | |
| | Amount* | 100 | 100 | 100 | 100 | 100 |
| Water | Amount* | 40 | 40 | 40 | 40 | 40 |
| Resin fine | Type | Acrylic | Acrylic particles | Acrylic | Acrylic particles | Acrylic particles |
| particles | | particles | | particles | | |
| | D₅₀ | 100 μm | 100 μm | 100 μm | 100 μm | 100 μm |
| | Amount* | 100 | 100 | 100 | 34 | 34 |
| Inorganic | Type | Kaolin 2 | Kaolin 2 | Kaolin 2 | Kaolin 2 | Kaolin 2 |
| fine | D₅₀ | 100 μm | 100 μm | 100 μm | 100 μm | 100 μm |
| particles | Amount* | 20 | 20 | 6.6 | 6.0 | 6.6 |

| | | | | | |
|---|---|---|---|---|---|
| Recording medium | Good | Good | Excellent | Excellent | Excellent |
| texture | | | | | |
| UV curable ink | Excellent | Excellent | Excellent | Excellent | Excellent |
| permeability | | | | | |
| UV curable ink | Excellent | Excellent | Excellent | Excellent | Excellent |
| wettability and | | | | | |
| spreadability | | | | | |
| UV curable ink | Good | Good | Good | Good | Good |
| fixability | | | | | |
| Dot Sharpness | Good | Good | Good | Good | Good |
| Curling property | Excellent | Excellent | Excellent | Excellent | Excellent |

*(parts by mass),
**Amphoteric polyacrylamide,
***Diallyldimethyl-ammoniumchloride polymer 1,
****Diallyldimethyl-ammoniumchloride acrylamide copolymer

TABLE 2

| | | Ex. 10 | Ex. 11 | Ex. 12 | Ex. 13 | Ex. 14 |
|---|---|---|---|---|---|---|
| Hydrophilic | Type | (PAS-H-5L)* | (PAS-H-5L)* | (PAS-H-5L)* | (PAS-H-5L)* | (PAS-H-5L)* |
| polymer | Amount | 34 | 34 | 34 | 34 | 34 |
| | (parts by mass) | | | | | |
| Hydrophilic | Type | Glycerin | Glycerin | Glycerin | Glycerin | Glycerin |
| solvent | Amount | 100 | 100 | 100 | 100 | 100 |
| Water | Amount | 20 | 20 | 20 | 20 | 20 |
| | (parts by mass) | | | | | |
| Resin fine | Type | Acrylic | Rubber** 1 | Rubber** 2 | Rubber** 1 | Rubber** 1 |
| particles | | particles | | | | |
| | D₅₀ | 100 μm | 0.7 μm | 0.22 μm | 0.7 μm | 0.7 μm |
| | Amount | 34 | 34 | 34 | 34 | 34 |
| | (parts by mass) | | | | | |
| Inorganic | Type | Calcium | Talc | Vapor phase | Calcium | Calcium |
| fine particles | | carbonate | | silica | carbonate | carbonate |
| | D₅₀ | 0.72 μm | 10.2 x 1.02 μm | 0.2 μm | 0.72 μm | 0.72 μm |
| | Amount | 6.6 | 6.6 | 6.6 | 1.0 | 10 |
| | (parts by mass) | | | | | |

| | | | | | |
|---|---|---|---|---|---|
| Recording medium texture | Excellent | Excellent | Excellent | Excellent | Excellent |
| UV curable ink permeability | Excellent | Excellent | Excellent | Good | Excellent |
| UV curable ink wettability and | Excellent | Excellent | Excellent | Excellent | Excellent |
| spreadability | | | | | |
| UV curable ink fixability | Excellent | Excellent | Excellent | Excellent | Excellent |
| Dot sharpness | Excellent | Excellent | Excellent | Excellent | Excellent |
| Curling property | Excellent | Excellent | Excellent | Excellent | Excellent |

| | | Ex. 15 | Ex. 16 | Ex. 17 | Ex. 18 |
|---|---|---|---|---|---|
| Hydrophilic | Type | (PAS-H-5L)* | (PAS-H-5L)* | (PAS-H-5L)* | (PAS-H-5L)* |
| polymer | Amount | 34 | 34 | 1 | 40 |
| | (parts by mass) | | | | |
| Hydrophilic | Type | Glycerin | Glycerin | Glycerin | Glycerin |
| solvent | Amount | 100 | 100 | 100 | 100 |
| Water | Amount | 20 | 20 | 20 | 20 |
| | (parts by mass) | | | | |
| Resin fine | Type | Rubber** 2 | Rubber** 2 | Rubber** 2 | Rubber** 2 |
| particles | | | | | |
| | D₅₀ | 0.22 μm | 0.22 μm | 0.22 μm | 0.22 μm |
| | Amount | 1 | 40 | 34 | 34 |
| | (parts by mass) | | | | |
| Inorganic | Type | Calcium | Calcium | Calcium | Calcium |
| fine particles | | carbonate | carbonate | carbonate | carbonate |
| | D₅₀ | 0.72 μm | 0.72 μm | 0.72 μm | 0.72 μm |
| | Amount | 6.6 | 6.6 | 6.6 | 6.6 |
| | (parts by mass) | | | | |

| | | | | |
|---|---|---|---|---|
| Recording medium texture | Excellent | Good | Excellent | Excellent |
| UV curable ink permeability | Good | Excellent | Good | Excellent |
| UV curable ink wettability and | Good | Excellent | Excellent | Excellent |
| spreadability | | | | |
| UV curable ink fixability | Excellent | Excellent | Excellent | Excellent |
| Dot sharpness | Excellent | Excellent | Excellent | Excellent |
| Curling property | Excellent | Excellent | Excellent | Excellent |

*Diallyldimethyl-ammoniumchloride polymer 2,
**Styrene/butadiene rubber

TABLE 3

| | | Ex. 19 | Comp. Ex. 2 | Comp. Ex. 3 | Comp. Ex. 4 |
|---|---|---|---|---|---|
| Hydrophilic | Type | Diallyldimethyl- | — | PVA + Polyamine | Polyallylamine |
| polymer | | ammoniumchloride | | epihalohydrin | hydrochloride |
| | | polymer 2 | | (4:15) | polymer |
| | | (PAS-H-5L) | | | |
| | Amount (parts | 525 | — | 19.0 | 334 |
| | by mass) | | | | |
| Hydrophilic | Type | Glycerin | Isopropyl alcohol + | — | 1,2-Hexanediol + |
| solvent | | | 1-Butyl alcohol | | Triethanolamine |
| | | | (1:1) | | |
| | Amount (parts | 100 | 100 | — | 100 |
| | by mass) | | | | |
| Water | Amount (parts | 50 | — | 32.0 | 1195.7 |
| | by mass) | | | | |
| Resin fine | Type | Styrene/butadiene | — | — | — |
| particles | | rubber 2 | | | |
| | D₅₀ | 0.22 μm | — | — | — |
| | Amount (parts | 85 | — | — | — |
| | by mass) | | | | |
| Inorganic | Type | Calcium carbonate | — | Heavy calcium | — |
| fine particles | | | | carbonate | |
| | D₅₀ | 0.72 μm | — | 4.9 μm | — |
| | Amount (parts | 16.5 | — | 100 | — |
| | by mass) | | | | |
| Additional | Type | | Component above | — | Component above |
| component | Amount (parts | | 233 | — | 40.1 |
| | by mass) | | | | |

| | | | | |
|---|---|---|---|---|
| Recording medium texture | Good | Poor | Excellent | Poor |
| UV curable ink permeability | Excellent | Excellent | Poor | Poor |
| UV curable ink wettability | Excellent | Good | Poor | Poor |
| and spreadability | | | | |
| UV curable ink fixability | Excellent | Excellent | Good | Good |
| Dot sharpness | Excellent | Excellent | Good | Good |
| Curling property | Excellent | Excellent | Poor | Poor |

As shown in Tables 1 to 3, the texture of a recording medium was less likely to be impaired when a hydrophilic polymer, hydrophilic solvent, and water were contained, and the amount of the hydrophilic polymer was 1 part by mass or more and 100 parts by mass or less with respect to 100 parts by mass of the hydrophilic solvent (examples 1 to 19 and comparative example 1). However, when the resin fine particles were not contained, the UV curable ink was more likely to penetrate (comparative example 1). On the other hand, when the resin fine particles were contained, the UV curable ink was less likely to penetrate, and the wettability and spreadability and the fixability were also excellent. The sharpness of the dots was also excellent (examples 1 to 19).

As shown in Table 3, when a UV curable precoat liquid was used, the ink permeability was excellent, but the texture of the recording medium was more likely to be impaired (comparative example 2). In addition, when a precoat liquid containing no hydrophilic solvent was used, curling was easily occur to impair the conveyance property because water breaks the hydrogen bonds of cellulose in the paper and the bonds are formed again during the drying (comparative example 3). Even when a hydrophilic polymer, a hydrophilic solvent, and water were contained, without the presence of the resin fine particles, the UV curable ink was less likely to stay on the surface, thereby lowering the ink permeability evaluation, and the amount of the hydrophilic polymer with respect to the hydrophilic solvent was large (comparative example 4). Further, in this case, the wettability and spreadability of the ink was also low.

### INDUSTRIAL APPLICABILITY

Applying a precoat liquid of the present invention allows application of an actinic radiation-curable ink even on an absorbent recording medium. The texture of the recording medium is less likely to be impaired when the precoat liquid is used. Therefore, the precoat liquid is particularly advantageous in various printing fields.

What is claimed is:

1. A precoat liquid for an actinic radiation-curable ink, the precoat liquid comprising:
a hydrophilic polymer;
a hydrophilic solvent;
water; and
resin fine particles, wherein
an amount of the hydrophilic polymer is 1 part by mass or more and 100 parts by mass or less with respect to 100 parts by mass of the hydrophilic solvent.

2. The precoat liquid according to claim 1, wherein:
the hydrophilic polymer includes a nitrogen-containing compound.

3. The precoat liquid according to claim 1, wherein:
the amount of the hydrophilic polymer is 1 part by mass or more and 40 parts by mass or less with respect to 100 parts by mass of the hydrophilic solvent.

4. The precoat liquid according to claim 1, wherein:
the hydrophilic solvent has two or more hydroxyl groups per molecule.

5. The precoat liquid according to claim 1, wherein:
the hydrophilic solvent has three or more hydroxyl groups per molecule.

6. The precoat liquid according to claim 1, wherein:
an amount of the resin fine particles is 1 part by mass or more and 100 parts by mass or less with respect to 100 parts by mass of the hydrophilic solvent.

7. The precoat liquid according to claim 6, wherein:
the amount of the resin fine particles is 1 part by mass or more and 40 parts by mass or less with respect to 100 parts by mass of the hydrophilic solvent.

8. The precoat liquid according to claim 6, wherein:
a volume 50% average particle diameter of the resin fine particles measured by a laser light scattering method is 0.2 to 150 μm.

9. The precoat liquid according to claim 1, further comprising inorganic fine particles.

10. The precoat liquid according to claim 9, wherein:
the inorganic fine particles include at least one member selected from the group consisting of vapor phase silica, calcium carbonate, talc, and kaolin.

11. The precoat liquid according to claim 9, wherein:
an amount of the inorganic fine particles is 50 parts by mass or less with respect to 100 parts by mass of the hydrophilic solvent.

12. The precoat liquid according to claim 9, wherein:
a volume 50% average particle diameter of the inorganic fine particles measured by a laser light scattering method is 0.2 to 10 μm.

13. A method for producing a printed matter, the method comprising:
applying the precoat liquid according to claim 1 on an recording medium having absorbency; and
applying an actinic radiation-curable ink on a region, on which the precoat liquid is applied, in the recording medium and curing the actinic radiation-curable ink.
